(19) United States
(12) Patent Application Publication
(10) Pub. No.: US 2026/0322130 A1
(43) Pub. Date: Oct. 15, 2026

(54) PLANNING APPARATUS, PLANNING METHOD AND PROGRAM

(71) Applicant: NTT, Inc., Tokyo (JP)

(72) Inventors: Kengo URATA, Tokyo (JP); Shigeaki HARADA, Tokyo (JP)

(21) Appl. No.: 19/484,144

(22) PCT Filed: May 22, 2023
(86) PCT No.: PCT/JP2023/019024

§ 371 Date: Nov. 13, 2025

(51) Int. Cl. H02J 3/32; H02J 103/40

(52) U.S. Cl. CPC H02J 3/32; H02J 2103/40

(57) ABSTRACT

An apparatus for planning charge/discharge of power, the apparatus including a processor, and a memory storing program instructions that cause the processor to calculate a charge/discharge amount for each of predetermined time intervals by an algorithm that uses a power demand for each of the predetermined time intervals within a predetermined period, upper and lower limit values of the power demand, a contracted capacity within the predetermined period, a baseline for each of the predetermined time intervals, parameters related to a charging/discharging device, and adjustment parameters to calculate the charge/discharge amount for each of the predetermined time intervals.

### TECHNICAL FIELD

The present disclosure relates to a planning apparatus, a planning method, and a program.

### BACKGROUND ART

In order to cope with demand response (DR) that occurs when a power consumer enters a capacity market and a power system is in a tight supply-demand situation, it is important to ensure a power demand suppression amount for a capacity that has been contracted at the time of the DR issuance and reduce economic losses. Many studies on power control on the consumer side have been reported in the prior art, and many studies using mathematical optimization have been described in NPL 1.

In order to ensure a power demand suppression amount at the time of DR issuance, it is conceivable to self-consume the power previously stored in a storage battery. In this case, it is necessary to appropriately determine a plan to charge/discharge the storage battery in accordance with predicted power demand information at the time of DR issuance.

### CITATION LIST

### Non-Patent Literature

[NPL 1] Panda, Subhasis, et al. “Residential Demand Side Management model, optimization and future perspective: A review.” Energy Reports, 8, 3727-3766, 2022.

### SUMMARY OF INVENTION

### Technical Problem

However, prediction of power demand generally includes a prediction error. For this reason, if charge/discharge is planned without considering a prediction error, an economic penalty due to insufficient discharge or inefficient power storage consumption due to excessive discharge may occur, for example.

The present disclosure has been made in view of the foregoing, and provides a technique capable of planning charge/discharge of a storage battery in consideration of a prediction error of power demand.

### Solution to Problem

A planning apparatus according to one aspect of the present disclosure is a planning apparatus for planning charge/discharge of a storage battery within a target period of demand response, including: a first acquisition unit configured to acquire a predetermined number of samples of power demand for each of spots representing respective time intervals within the target period; a first upper and lower limit value setting unit configured to set upper and lower limit values of the power demand for each of the spots; a second acquisition unit configured to acquire a contracted capacity within the target period and a baseline for each of the spots; a third acquisition unit configured to acquire parameters related to the storage battery; a second setting unit configured to set adjustment parameters including a weight with respect to a penalty representing nonachievement of a requirement, a weight with respect to a penalty representing opportunity loss due to over-discharge, and a parameter with respect to uncertainty of the power demand; a solution unit configured to determine a charge/discharge amount for each of the spots through a distributional robust optimization method by using the power demand, the upper and lower limit values, the contracted capacity, the baseline, the parameters related to the storage battery, and the adjustment parameters; and a third setting unit configured to set the charge/discharge amount for each of the spots as a charge/discharge plan for the storage battery.

### Advantageous Effects of Invention

A technique capable of planning charge/discharge of a storage battery in consideration of a prediction error of power demand is provided.

### BRIEF DESCRIPTION OF DRAWINGS

FIG. 1 is a diagram illustrating an example of an operation period and a demand response target period.

FIG. 2 is a diagram illustrating an example of a charge/discharge plan for a storage battery.

FIG. 3 is a diagram illustrating an example of problems when a prediction error is included in power demand.

FIG. 4 is a diagram illustrating an example of a hardware configuration of a charge/discharge planning apparatus according to the present embodiment.

FIG. 5 is a diagram illustrating an example of a functional configuration of the charge/discharge planning apparatus according to the present embodiment.

FIG. 6 is a flowchart illustrating an example of a flow of charge/discharge planning processing according to the present embodiment.

### DESCRIPTION OF EMBODIMENTS

Hereinafter, embodiments of the present invention will be described.

### <Conventional Methods and Problems Related to Power Control on Consumer Side>

NPL 1 is a survey paper of methods of controlling power on the consumer side using mathematical optimization. Among such methods, two mathematical optimization techniques, stochastic optimization and robust optimization, are particularly used for power control capable of coping with DR in consideration of prediction errors in power demand prediction.

Stochastic optimization is a method of constructing a sample distribution on the basis of data representing power demand accumulated in advance and optimizing the sample distribution by regarding the same as the true probability distribution itself. On the other hand, robust optimization is a method of predetermining a possible set of power demands including prediction errors and optimizing the worst case power demand belonging to the set.

However, stochastic optimization actually has a problem that errors present between a sample distribution and a true probability distribution greatly affect performance, and in particular, when the number of pieces of data is small, the performance of optimization greatly deteriorates. On the other hand, robust optimization only captures the worst case belonging to a possible set of power demands, and thus a frequency distribution or the like in the possible set of power demands cannot be considered, and as a result, there is an issue that data representing power demand accumulated in advance is not utilized effectively, resulting in conservative optimization.

Therefore, a method that has introduced a distributionally robust optimization method (refer to Reference Literature 1) is proposed below. The distributionally robust optimization method is a robust optimization method that takes into account the uncertainty of an assumed probability distribution. In this proposed method, a set representing uncertainty is defined on the basis of a Wasserstein distance measuring the degree of divergence between a true probability distribution and an actually obtained sample distribution, and then the set is used to formulate a charge/discharge plan for a storage battery for coping with a DR request in a capacity market as distributionally robust optimization. Then, by bringing the distributionally robust optimization into an optimization problem of a class that can be solved, a robust charge/discharge plan for uncertainty of power demand prediction is realized.

### <Proposed Method>

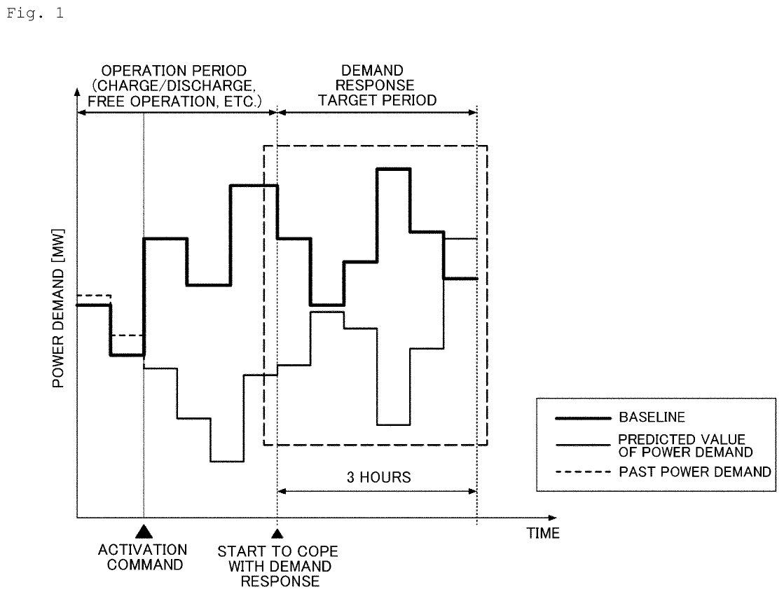

Hereinafter, the proposed method will be described. This proposed method targets the capacity market and considers a charge/discharge plan for a storage battery that appropriately copes with a DR request within a three-hour period designated by a DR activation command, as illustrated in FIG. 1. In the example illustrated in FIG. 1, the DR activation command is issued at a certain time in the operation period, and three hours between two hours and five hours after the certain time are the DR target period. The baseline in the example illustrated in FIG. 1 is a power demand amount assumed when control related to power demand suppression is not performed (refer to Reference Literature 2).

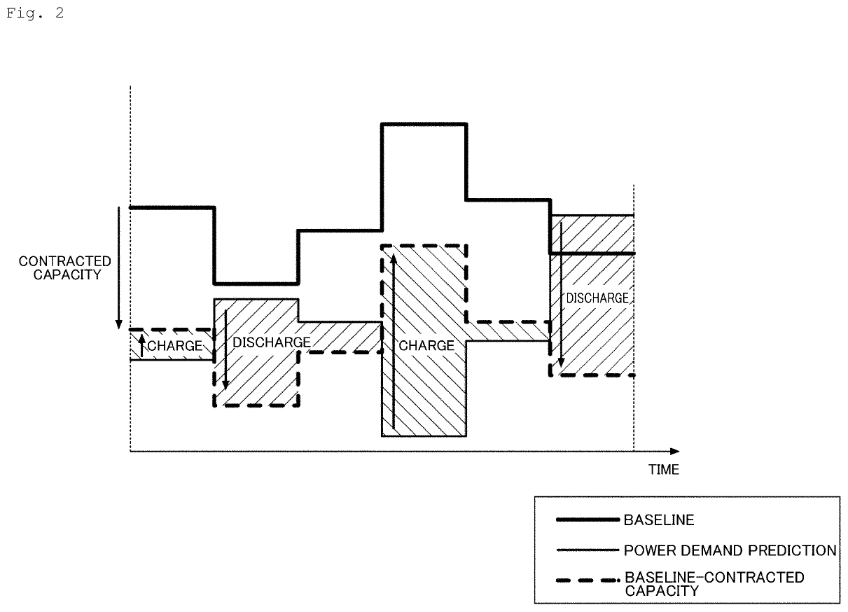

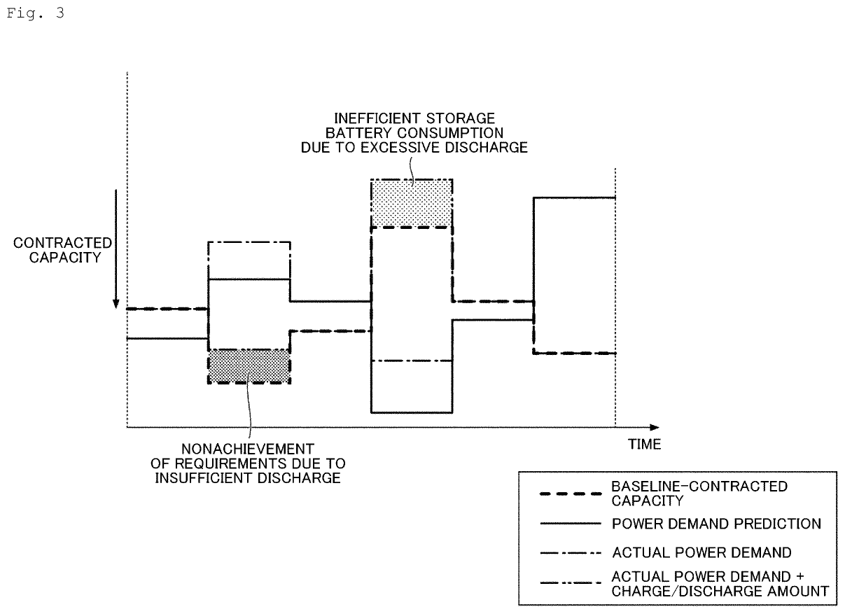

Further, in the proposed method, it is assumed that a consumer designates a charge/discharge amount of a storage battery in advance every 30 minutes within the DR target period, and the time width in units of 30 minutes is called a “spot.” For example, as illustrated in FIG. 2, the consumer determines a charge/discharge plan for the storage battery by designating the charge/discharge amount of the storage battery at each spot. The example illustrated in FIG. 2 represents a case in which a certain amount of power is charged for 30 minutes (first spot) from the start of the DR target period, a certain amount of power is discharged for the next 30 minutes (second spot), and a certain amount of power is discharged for the next 30 minutes (third spot), . . . , and a certain amount of power is discharged for the last 30 minutes (sixth spot). In the example illustrated in FIG. 3, “baseline-contracted capacity” is a value obtained by subtracting a contracted capacity (that is, a power demand amount determined by a contract) from the baseline. When the “baseline-contracted capacity” exceeds power demand, the insufficient power amount is designated to be met by discharging the storage battery, and when the baseline-contracted capacity is below the power demand, the difference is designated to be used to charge the storage battery.

However, generally, power demand includes prediction errors. For this reason, for example, there is a possibility of nonachievement of requirements due to insufficient discharge, or inefficient battery consumption due to excessive discharge, as shown in FIG. 3. In the example shown in FIG. 3, at the second spot, the actual power demand exceeds power demand prediction, resulting in insufficient discharge, and as a result, nonachievement of requirements occurs. Therefore, an economic penalty may occur. Further, at the fourth spot, the actual power demand exceeds power demand prediction, causing excessive discharge to the storage battery (in other words, an excessive charge amount), resulting in discharge from the storage battery, causing inefficient storage battery consumption.

Accordingly, in the present proposed method, a case will be described where a charge/discharge plan for a storage battery that satisfies a DR request robustly against prediction errors in power demand (in other words, robustly against uncertainty regarding the probability distribution of power demand) is determined.

It is assumed that a spot set within a DR target period is K:={1, 2, . . . , 6}. Here, a contracted capacity is represented by p, power demand at each spot k ∈ K is represented by xₖ, a baseline value is represented by bₖ, and the charge/discharge amount of the storage battery is represented by xₖ. It is assumed that the baseline value bₖ is determined when a DR issuance command has been received on the basis of past power demand records and the like, and is obtained in advance. It is also assumed that the charge/discharge amount xₖ means charge when it takes a positive value and discharge when it takes a negative value.

Next, parameters relating to the storage battery to be charged/discharged are defined. It is assumed that the maximum capacity of the storage battery for coping with DR is C, the charge/discharge rate (charge/discharge performance per unit time) is a, and the charge amount (initial residual amount) at the start point within the DR target period is x₀.

In order to define an uncertainty set with respect to the probability distribution Q (precisely, Q is represented as a blackboard character (or outlined character), but in the text of the present specification, it will be written as “Q” in a normal character. Other blackboard characters or outlined characters will also be written in normal characters in the text of the present specification.) of a power demand vector d:=[d₁, d₂, . . . , d_{|K|}] having M as a |K|-dimensional measurable space, a measure for measuring the distance between two probability distributions called a Wasserstein distance is introduced. For probability distributions Q₁, Q₂ ∈ M, the Wasserstein distance W:M×M→R (where R is a set of all real numbers) is defined below.

W( [symbol] ₁, [symbol] ₂):=inf{∫_{Ξ2}∥ξ₁−ξ₂∥Π(dξ₁,dξ₂)} [Math. 1]

Here, E represents a region that can be taken by ξ₁ and ξ₂, and Π represents a joint probability distribution with marginal distributions as Q₁ and Q₂. The region E that can be taken by the power demand vector d is described below with the upper limit value of the power demand at each spot being d_{u,k} and the lower limit value being d₁,k.

E:={d∈ [symbol] : [symbol] ≤dₖ≤d_{u,k},∀k∈ [symbol] } [Math. 2]

Here, the uncertainty set for the probability distribution Q of the power demand vector d is defined by the following formula (1).

[Math. 3]

[symbol]

:={ [symbol] ∈ [symbol] :W( [symbol] _{N}, [symbol] )≤ε} (1)

Here, \hat{ }P_{N} (precisely, the hat symbol “\hat{ }” is written immediately above P_{N}, but in the text of the present specification, it is written immediately before P_{N}.) is a sample distribution when N power demand vectors are given. Further, ε is a parameter that defines the Wasserstein distance between the true probability distribution Q and the sample distribution \hat{ }P_{N} with respect to the power demand vector d.

The uncertainty set given by the above formula (1) means that the true probability distribution Q is present in the Wasserstein sphere defined by the radius E.

Under the above preparation, a charge/discharge plan for the storage battery that properly copes with a DR request even under uncertainty regarding the probability distribution of the power demand defined by the above formula (1) is formulated as distributionally robust optimization shown in the following (2a) to (2c).

$$\begin{matrix}[ Math . 4 ] & \\ {min}_{{x}_{i}} {max}_{ℚ ∈ 𝔻} {𝔼}_{ℚ} [ {\sum }_{k ∈ 𝒦} {J}_{k} ( {x}_{k} , {d}_{k} ) + β {\sum }_{k ∈ 𝒦} \vert {x}_{k} \vert ] & ( 2 a )\end{matrix}$$

$$\begin{matrix}s . t . 0 \leq {x}_{0} + {\sum }_{i = 1}^{k} {x}_{i} \leq C , & ∀ k ∈ 𝒦\end{matrix} \qquad ( 2 b )$$

$$\begin{matrix}- aT \leq {x}_{k} \leq aT , & ∀ k ∈ 𝒦\end{matrix} \qquad ( 2 c )$$

Here, a function Jₖ(xₖ, dₖ) is represented by the following formula (3).

$$\begin{matrix}[ Math . 5 ] & \\ {J}_{k} ( {x}_{k} , {d}_{k} ) := \{ \begin{matrix}{α}_{k}^{1} ( p - {b}_{k} + {d}_{k} + {x}_{k} ) , & p - {b}_{k} + {d}_{k} + {x}_{k} \geq 0 \\ - {α}_{k}^{2} ( p - {b}_{k} + {d}_{k} + {x}_{k} ) , & p - {b}_{k} + {d}_{k} + {x}_{k} < 0\end{matrix} & ( 3 )\end{matrix}$$

In the function Jₖ (xₖ, dₖ) represented by the above formula (3), p−bₖ+dₖ+xₖ≥0 means a case where nonachievement of requirements occurs, which is a penalty for not being able to cope with DR. On the other hand, p−bₖ+dₖ+xₖ<0 means a case where a penalty with respect to opportunity loss due to over-discharge (power that was not served for consumer's benefit as a result of discharging that exceeds the minimum amount of power required to suppress nonachievement of requirements) has occurred. Further, aₖ¹ and aₖ²≥0 each represent a weight of a penalty at each spot.

In the optimization problems described through the above formulas (2a) to (2c), for the probability distribution Q in the worst case under a situation in which the probability distribution Q of the power demand vector d fluctuates within the range constrained by uncertainty set D thereof, the expected value of the L₁ norm of the vector whose elements are the function Jₖ(xₖ, dₖ) given by the above formula (3) and the charge/discharge amount xₖ is minimized (formula (2a)). Here, β≥0 is a weight with respect to the L₁ norm. This also takes into account a regularization term for the charge/discharge amount, and serves to penalize an operation of repeating charging and discharging wastefully, in addition to a penalty representing nonachievement of requirements and a penalty due to opportunity loss. Further, the inequality shown in (2b) means the restriction that charging cannot be performed more than the storage capacity at each spot and that discharging cannot be performed without regard to an insufficient capacity. Finally, the inequality shown in (2c) represents the restriction on the charge/discharge capacity at each spot, and T=1800 [s].

In order to provide an algorithm for solving the optimization problem shown in the above formulas (2a) to (2c), this is brought into an optimization problem of a resolvable class equivalent to the formulas (2a) to (2c). When an i-th sampled power demand is assumed to be dₖ⁽ⁱ⁾, the above formulas (2a) to (2c) can result in the following optimization problem.

$$\begin{matrix}[ Math . 6 ] & \\ {min}_{{x}_{k} , {η}_{k} , λ , {s}_{ki} , {γ}_{ki}^{1} , {γ}_{ki}^{2}} λ ε + \frac{1}{N} {\sum }_{i = 1}^{k} {\sum }_{k ∈ 𝒦} {s}_{ki} & ( 4 a )\end{matrix}$$

$$s . t . {α}_{k}^{1} ( p - {b}_{k} + {d}_{k}^{( i )} + {x}_{k} ) + \frac{β}{\vert 𝒦 \vert} {η}_{k} + {{γ}_{ki}^{2}}^{⊤} [ \begin{matrix}{d}_{u , k} - {d}_{k}^{( i )} \\ - {d}_{ℓ , k} + {d}_{k}^{( i )}\end{matrix} ] \leq {s}_{ki} , ∀ k ∈ 𝒦 , ∀ i ∈ \{ 1 , 2 , … N \} \qquad ( 4 b )$$

$$- {α}_{k}^{2} ( p - {b}_{k} + {d}_{k}^{( i )} + {x}_{k} ) + \frac{β}{\vert 𝒦 \vert} {η}_{k} + {{γ}_{ki}^{2}}^{⊤} [ \begin{matrix}{d}_{u , k} - {d}_{k}^{( i )} \\ - {d}_{ℓ , k} + {d}_{k}^{( i )}\end{matrix} ] \leq {s}_{ki} , ∀ k ∈ 𝒦 , ∀ i ∈ \{ 1 , 2 , … N \} \qquad ( 4 c )$$

$$- λ \leq [ 1 - 1 ] {γ}_{ki}^{1} - {α}_{k}^{1} \leq λ , ∀ k ∈ 𝒦 , ∀ i ∈ \{ 1 , 2 , … N \} \qquad ( 4 d )$$

$$- λ \leq [ 1 - 1 ] {γ}_{ki}^{2} - {α}_{k}^{2} \leq λ , ∀ k ∈ 𝒦 , ∀ i ∈ \{ 1 , 2 , … N \} \qquad ( 4 e )$$

$${γ}_{ki}^{1} , {γ}_{ki}^{2} \geq 0 , ∀ k ∈ 𝒦 , ∀ i ∈ \{ 1 , 2 , … N \} \qquad ( 4 f )$$

$$\begin{matrix}- {η}_{k} \leq {x}_{k} \leq {η}_{k} , & ∀ k ∈ 𝒦\end{matrix} \qquad ( 4 g )$$

$$\begin{matrix}0 \leq {x}_{0} + {\sum }_{i = 1}^{k} {x}_{i} \leq C , & ∀ k ∈ 𝒦\end{matrix} \qquad ( 4 h )$$

$$\begin{matrix}- aT \leq {x}_{k} \leq aT & ∀ k ∈ 𝒦\end{matrix} \qquad ( 4 i )$$

Here, N is the number of power demand samples.

The optimization problem shown in the above formulas (4a) to (4i) is a linear programming problem and thus can be easily solved with existing solvers.

Hereinafter, a charge/discharge planning apparatus 10 capable of planning charge/discharge of a storage battery by obtaining the charge/discharge amount xₖ at each spot within the DR target period through the present proposed method will be described.

### Example of Hardware Configuration of Charge/discharge Planning Apparatus 10

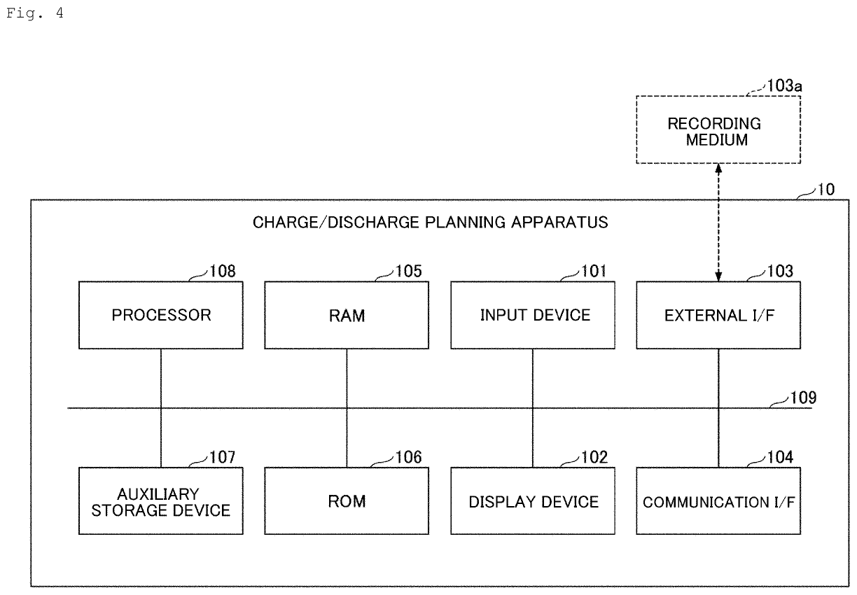

FIG. 4 illustrates a hardware configuration example of the charge/discharge planning apparatus 10 according to the present embodiment. As illustrated in FIG. 4, the charge/discharge planning apparatus 10 according to the present embodiment includes an input device 101, a display device 102, an external I/F 103, a communication I/F 104, a random access memory (RAM) 105, a read only memory (ROM) 106, an auxiliary storage device 107, and a processor 108. These pieces of hardware are connected via a bus 109 such that they can communicate.

The input device 101 is, for example, a keyboard, a mouse, a touch panel, physical buttons, or the like. The display device 102 is, for example, a display, a display panel, or the like. For example, the charge/discharge planning apparatus 10 need not include at least one of the input device 101 or the display device 102.

The external I/F 103 is an interface with an external device such as a recording medium 103a. Examples of the recording medium 103a include a compact disc (CD), a digital versatile disk (DVD), a secure digital (SD) memory card, a Universal Serial Bus (USB) memory card, and the like.

The communication I/F 104 is an interface through which the charge/discharge planning apparatus 10 is connected to a communication network. The RAM 105 is a volatile semiconductor memory (storage device) that temporarily retains a program and data. The ROM 106 is a nonvolatile semiconductor memory (storage device) that can retain a program and data even when power is cut off. The auxiliary storage device 107 is, for example, a storage device such as a hard disk drive (HDD), a solid state drive (SSD), or a flash memory. Examples of the processor 108 include various arithmetic units such as a central processing unit (CPU) and a graphics processing unit (GPU).

The hardware configuration shown in FIG. 4 is exemplary and the hardware configuration of the charge/discharge planning apparatus 10 is not limited thereto. For example, the charge/discharge planning apparatus 10 may include a plurality of auxiliary storage devices 107 and a plurality of processors 108, need not include parts of the illustrated hardware, or may include various types of hardware other than the illustrated hardware.

### Functional Configuration Example of Charge/discharge Planning Apparatus 10

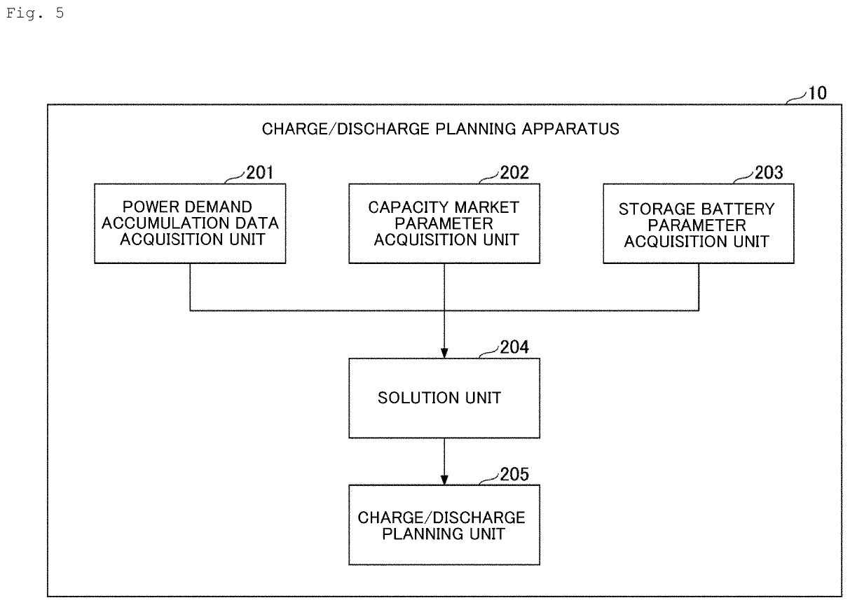

FIG. 5 illustrates a functional configuration example of the charge/discharge planning apparatus 10 according to the present embodiment. As illustrated in FIG. 5, the charge/discharge planning apparatus 10 according to the present embodiment includes a power demand accumulation data acquisition unit 201, a capacity market parameter acquisition unit 202, a storage battery parameter acquisition unit 203, a solution unit 204, and a charge/discharge planning unit 205. Each of these units is realized, for example, through processing of executing one or more programs installed in the charge/discharge planning apparatus 10 by the processor 108 or the like. When a DR activation command is received, the DR target period is assumed to be designated by, for example, the activation command.

The power demand accumulation data acquisition unit 201 acquires N samples of power demand dₖ⁽ⁱ⁾ at each spot. Here, for example, the power demand dₖ⁽ⁱ⁾ is accumulated in advance in a database or the like, and the power demand accumulation data acquisition unit 201 may acquire N samples of power demand dₖ⁽ⁱ⁾ from the database. Each power demand dₖ⁽ⁱ⁾ may be any data that can construct a sample distribution of power demand at each spot (i.e., in each time interval of 30 minutes, for example). For example, it is possible to assume that the power demand in each time interval follows the same probability distribution on all days, and obtain the power demand values for past N days. Alternatively, a predicted value of the power demand in each time interval may be obtained by some prediction methods.

Further, the power demand accumulation data acquisition unit 201 sets upper and lower limit values d_{u,k} and d_{l,k} of power demand at each spot using the N samples of power demand dₖ⁽ⁱ⁾. The upper limit value d_{u,k} may be, for example, the maximum value of power demands dₖ⁽¹⁾, . . . , dₖ^{(N)}, a value obtained by adding a buffer value thereto, or the like. Similarly, the lower limit value d_{l,k} may be, for example, the minimum value of power demands dₖ⁽¹⁾, . . . , dₖ^{(N)}, a value obtained by subtracting a buffer value therefrom, or the like.

The capacity market parameter acquisition unit 202 acquires a contracted capacity p and a baseline value bₖ at each spot. The capacity market parameter acquisition unit 202 may acquire the contracted capacity p and the baseline value bₖ at each spot from a predetermined database or the like, for example.

The storage battery parameter acquisition unit 203 acquires a storage battery capacity C, a charge/discharge rate a, and a charge amount (initial residual amount) x₀ at a start point in the DR target period. The storage battery parameter acquisition unit 203 may acquire the storage battery capacity C, the charge/discharge rate a, and the initial residual amount x₀ from a predetermined database or the like, for example.

The solution unit 204 sets parameters aₖ¹ and aₓ²≥0 each representing a weight of a penalty at each spot, aa parameter β≥0 representing a weight with respect to L₁ norm, and a parameter ε≥0 with respect to a Wasserstein sphere for defining the uncertainty of power demand, and then solves the optimization problem shown in the above formulas (4a) to (4i) to determine a charge/discharge amount xₖ at each spot. These parameters (adjustment parameters) aₖ¹ and aₖ²≥0, β≥0, and ε≥0 can be set arbitrarily.

The charge/discharge planning unit 205 sets the charge/discharge amount xₖ determined by the solution unit 204 as a charge/discharge plan for the storage battery.

Accordingly, the storage battery is charged and discharged by the charge/discharge amount xₖ when the time interval indicated by a spot k comes.

### <Flow of Charge/discharge Planning Processing>

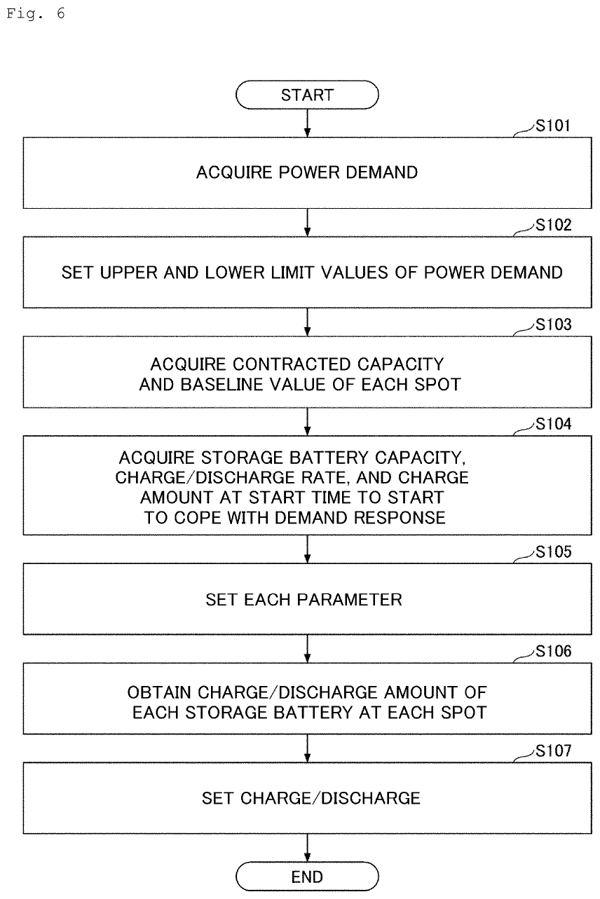

The flow of charge/discharge planning processing according to the present embodiment will be described with reference to FIG. 6.

First, the power demand accumulation data acquisition unit 201 acquires N samples of power demand dₖ⁽ⁱ⁾ at each spot (step S101). That is, the power demand accumulation data acquisition unit 201 acquires dₖ⁽¹⁾, . . . dₖ^{(N)} for each k ∈ K.

Next, the power demand accumulation data acquisition unit 201 sets upper and lower limit values d_{u,k} and d_{l,k} of power demand at each spot using the N samples of power demand dₖ⁽ⁱ⁾ (step S102).

Next, the capacity market parameter acquisition unit 202 acquires a contracted capacity p and a baseline value bₖ at each spot (step S103).

Next, the storage battery parameter acquisition unit 203 acquires a storage battery capacity C, a charge/discharge rate a, and a charge amount (initial residual amount) x₀ at a start point in a DR target period (step S104).

Next, the solution unit 204 sets parameters aₖ¹ and aₖ²≥0 each representing a weight of a penalty at each spot, a parameter β≥0 representing a weight with respect to L₁ norm, and a parameter ε>0 with respect to a Wasserstein sphere for defining the uncertainty of power demand (step S105).

Next, the solution unit 204 solves the optimization problem shown in the above formulas (4a) to (4i) using the N samples of power demand dₖ⁽ⁱ⁾, the upper and lower limit values d_{u,k} and d_{l,k}, the contracted capacity p, the baseline value bₖ at each spot, the storage battery capacity C, the charge/discharge rate a, the initial residual amount x₀ at the start time point within the DR target period, and the parameters aₖ¹, aₖ², β, and ε to determine a charge/discharge amount xₖ at each spot (step S106). The solution unit 204 may determine the charge/discharge amount xₖ (k ∈ K) using an existing solver.

Then, the charge/discharge planning unit 205 sets the charge/discharge amount xₖ(k ∈ K) determined in step S106 as a charge/discharge plan for the storage battery (step S107).

### <Conclusion>

As described above, according to the charge/discharge planning apparatus 10 according to the present embodiment, it is possible to achieve a charge/discharge plan in which a penalty representing nonachievement of requirements and a penalty representing opportunity loss due to over-discharge are appropriately minimized in a robust manner with respect to the uncertainty of a probability distribution of power demand. In particular, weighting for the penalty representing nonachievement of requirements at each spot and the penalty representing opportunity loss due to over-discharge can be adjusted using the parameters aₖ¹ and aₖ². Furthermore, the penalty for repeating charging and discharging recklessly can also be adjusted using the parameter β. Accordingly, robustness can be ensured in view of properly minimizing a penalty representing nonachievement of requirements and a penalty representing opportunity loss due to over-discharge even if a probability distribution of power demand estimated on the basis of data representing power demand accumulated in advance at the time of charge/discharge planning differs from a probability distribution of actual power demand.

Further, as characteristics of a distributional robust charge/discharge planning algorithm, when the number of samples of data representing power demand accumulated in advance is small, it is expected that results will be conservative and demonstrate guarantee of robustness by fully taking into account the presence of errors between a sample distribution and the true probability distribution due to the small number of samples. On the other hand, when the number of samples of data representing power demand accumulated in advance is sufficiently large, it is expected that conservativeness to ensure robustness is reduced and results that are closer to results of a probability planning method that makes full use of characteristics of the data are obtained. From the foregoing, the distributional robust charge/discharge planning algorithm can be regarded as an algorithm capable of determining a charge/discharge plan in which a penalty representing nonachievement of requirements and a penalty representing opportunity loss due to over-discharge can be properly suppressed by flexibly changing conservativeness for ensuring robustness in accordance with the size of the number of samples of data representing power demand.

The present invention is not limited to the foregoing specifically disclosed embodiments, and various modifications and changes, combinations with known techniques, and the like can be made without departing from the scope of the claims.

### REFERENCE LITERATURES

Reference Literature 1: Mohajerin Esfahani, Peyman, and Daniel Kuhn. “Data-driven distributionally robust optimization using the Wasserstein metric: Performance guarantees and tractable reformulations.” Mathematical Programming 171 (1-2), 115-166, 2018.
Reference Literature 2: Guidelines for energy resource aggregation business 20200601 revision, Agency for Natural Resources and Energy

### REFERENCE SIGNS LIST

10 Charge/discharge planning apparatus
101 Input device
102 Display device
103 External I/F
103a Recording medium
104 Communication I/F
105 RAM
106 ROM
107 Auxiliary storage device
108 Processor
109 Bus
201 Power demand accumulation data acquisition unit
202 Capacity market parameter acquisition unit
203 Storage battery parameter acquisition unit
204 Solution unit
205 Charge/discharge planning unit

1. An apparatus for planning charge/discharge of power, the apparatus comprising:
a processor, and
a memory storing program instructions that cause the processor to calculate a charge/discharge amount for each of predetermined time intervals by an algorithm that uses a power demand for each of the predetermined time intervals within a predetermined period, upper and lower limit values of the power demand, a contracted capacity within the predetermined period, a baseline for each of the predetermined time intervals, parameters related to a charging/discharging device, and adjustment parameters to calculate the charge/discharge amount for each of the predetermined time intervals.

2. The apparatus according to claim 1, wherein
the power demand is a predetermined number of samples of power demand for each of the predetermined time intervals within the predetermined period, and
the algorithm is an optimization method under uncertainty regarding the power demand.

3. The apparatus according to claim 1, wherein the charge/discharge amount for each of the predetermined time intervals is set as a charge/discharge plan.

4. The apparatus according to claim 1, wherein the adjustment parameters include a weight with respect to a penalty representing nonachievement of a requirement, a weight with respect to a penalty representing opportunity loss due to over-discharge, and a parameter related to uncertainty of the power demand.

5. The apparatus according to claim 2, wherein the charge/discharge amount for each of the predetermined time intervals is calculated by converting an optimization problem formulated by the optimization method into a linear programming problem equivalent to the optimization problem and solving the linear programming problem.

6. The apparatus according to claim 1, wherein the adjustment parameters include a parameter representing a penalty for repeating charging/discharging wastefully within the predetermined period.

7. The apparatus according to claim 4, wherein the parameter related to the uncertainty of the power demand is a parameter defining a Wasserstein distance between a probability distribution of the power demand and a true probability distribution of the power demand.

8. The apparatus according to claim 1, wherein the parameters related to the charging/discharging device include a storage capacity of the charging/discharging device, a charge/discharge rate of the charging/discharging device, and an initial residual amount of the charging/discharging device at a start of the predetermined period.

9. A method executed by a computer that plans charge/discharge of power, the method comprising:
calculating a charge/discharge amount for each of predetermined time intervals by an algorithm that uses a power demand for each of the predetermined time intervals within a predetermined period, upper and lower limit values of the power demand, a contracted capacity within the predetermined period, a baseline for each of the predetermined time intervals, parameters related to a charging/discharging device, and adjustment parameters to calculate the charge/discharge amount for each of the predetermined time intervals.

10. A non-transitory computer-readable recording medium storing a program for causing the computer to execute the method of claim 9.

11. A planning apparatus for planning charge/discharge of a storage battery within a target period of demand response, the planning apparatus comprising:
a processor, and
a memory storing program instructions that cause the processor to:
acquire a predetermined number of samples of power demand for each of spots representing respective time intervals within the target period;
set upper and lower limit values of the power demand for each of the spots;
acquire a contracted capacity within the target period and a baseline for each of the spots;
acquire parameters related to the storage battery;
set adjustment parameters including a weight with respect to a penalty representing nonachievement of a requirement, a weight with respect to a penalty representing opportunity loss due to over-discharge, and a parameter with respect to uncertainty of the power demand;
determine a charge/discharge amount for each of the spots through a distributionally robust optimization method by using the power demand, the upper and lower limit values, the contracted capacity, the baseline, the parameters related to the storage battery, and the adjustment parameters; and
set the charge/discharge amount for each of the spots as a charge/discharge plan for the storage battery.
